(19) United States
(12) Patent Application Publication
(10) Pub. No.: US 2017/0364946 A1
(43) Pub. Date: Dec. 21, 2017

(54) DETERMINATION DEVICE, DETERMINATION METHOD, AND NON-TRANSITORY COMPUTER READABLE STORAGE MEDIUM

(71) Applicant: YAHOO JAPAN CORPORATION, Tokyo (JP)

(72) Inventors: Yuki TAKI, Tokyo (JP); Kenichi YAMADA, Tokyo (JP); Sachio YAGI, Tokyo (JP)

(73) Assignee: YAHOO JAPAN CORPORATION, Tokyo (JP)

(21) Appl. No.: 15/450,573

(22) Filed: Mar. 6, 2017

(30) Foreign Application Priority Data
Jun. 17, 2016 (JP) 2016-120584

(51) Int. Cl. G06Q 30/02

(52) U.S. Cl. CPC G06Q 30/0244; G06Q 30/0267

(57) ABSTRACT

A determination device according to the present application includes an acquisition unit, a calculation unit, and a determination unit. The acquisition unit acquires user information that is information regarding a user who uses a terminal device that becomes a providing destination of content. The calculation unit calculates scores regarding a probability of the user performing a predetermined behavior for a plurality of pieces of the content on the basis of the user information acquired by the acquisition unit. The determination unit determines distribution content to be distributed to the terminal device on the basis of the scores of the plurality of pieces of content calculated by the calculation unit.

### CROSS-REFERENCE TO RELATED APPLICATION(S)

The present application claims priority to and incorporates by reference the entire contents of Japanese Patent Application No. 2016-120584 filed in Japan on Jun. 17, 2016.

### BACKGROUND OF THE INVENTION

### 1. Field of the Invention

The present invention relates to a determination device, a determination method, and a non-transitory computer readable storage medium.

### 2. Description of the Related Art

Conventionally, a technology to determine content to be distributed to a terminal device used by a user has been provided. For example, a technology to check app products already installed in the terminal device, to exclude the installed app products from advertisement targets, and to display advertisements of only app products that have not yet been installed is provided.

However, appropriate determination of the content to be distributed to the terminal device by the above-described conventional technology may be difficult. For example, only the determination of excluding the already installed app products from the advertisement targets, and displaying the advertisements of the app products that have not yet been installed cannot necessarily determine an appropriate advertisement to be distributed to individual users.

### SUMMARY OF THE INVENTION

It is an object of the present invention to at least partially solve the problems in the conventional technology.

According to one aspect of an embodiment, a determination device includes an acquisition unit that acquires user information that is information regarding a user who uses a terminal device that becomes a providing destination of content, a calculation unit that calculates scores regarding a probability of the user performing a predetermined behavior for a plurality of pieces of the content on the basis of the user information acquired by the acquisition unit, and a determination unit that determines distribution content to be distributed to the terminal device on the basis of the scores of the plurality of pieces of content calculated by the calculation unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of determination processing according to an embodiment;

FIG. 2 is a diagram illustrating an example of determination processing according to an embodiment;

FIG. 3 is a diagram illustrating a configuration example of a determination device according to an embodiment;

FIG. 4 is a diagram illustrating an example of a user attribute information storage unit according to an embodiment;

FIG. 5 is a diagram illustrating an example of a terminal information storage unit according to an embodiment;

FIG. 6 is a diagram illustrating an example of an app information storage unit according to an embodiment;

FIG. 7 is a diagram illustrating an example of an individual score information storage unit according to an embodiment;

FIG. 8 is a diagram illustrating an example of an advertising information storage unit according to an embodiment;

FIG. 9 is a flowchart illustrating an example of determination processing according to an embodiment;

FIG. 10 is a flowchart illustrating an example of determination processing according to an embodiment;

FIG. 11 is a diagram illustrating an example of ranking change according to an embodiment;

FIG. 12 is a diagram illustrating an example of ranking change according to an embodiment;

FIG. 13 is a diagram illustrating an example of ranking change according to an embodiment;

FIG. 14 is a diagram illustrating an example of ranking change according to an embodiment;

FIG. 15 is a diagram illustrating an example of ranking change according to an embodiment;

FIG. 16 is a flowchart illustrating an example of determination processing by ranking change according to an embodiment;

FIG. 17 is a diagram illustrating an example of determination of an advertisement based on rarity of a user in apps according to an embodiment; and

FIG. 18 is a hardware configuration diagram illustrating an example of a computer that realizes functions of the determination device.

### DETAILED DESCRIPTION OF THE PREFERRED EMBODIMENTS

Hereinafter, embodiments for implementing a determination device, a determination method, and a determination program according to the present application (hereinafter, called “embodiment”) will be described in detail with reference to the drawings. Note that the determination device, the determination method, and the determination program according to the present application are not limited by the embodiments. Further, the same portion in the embodiments is denoted with the same reference sign, and overlapping description is omitted.

### EMBODIMENT

1. Determination Processing

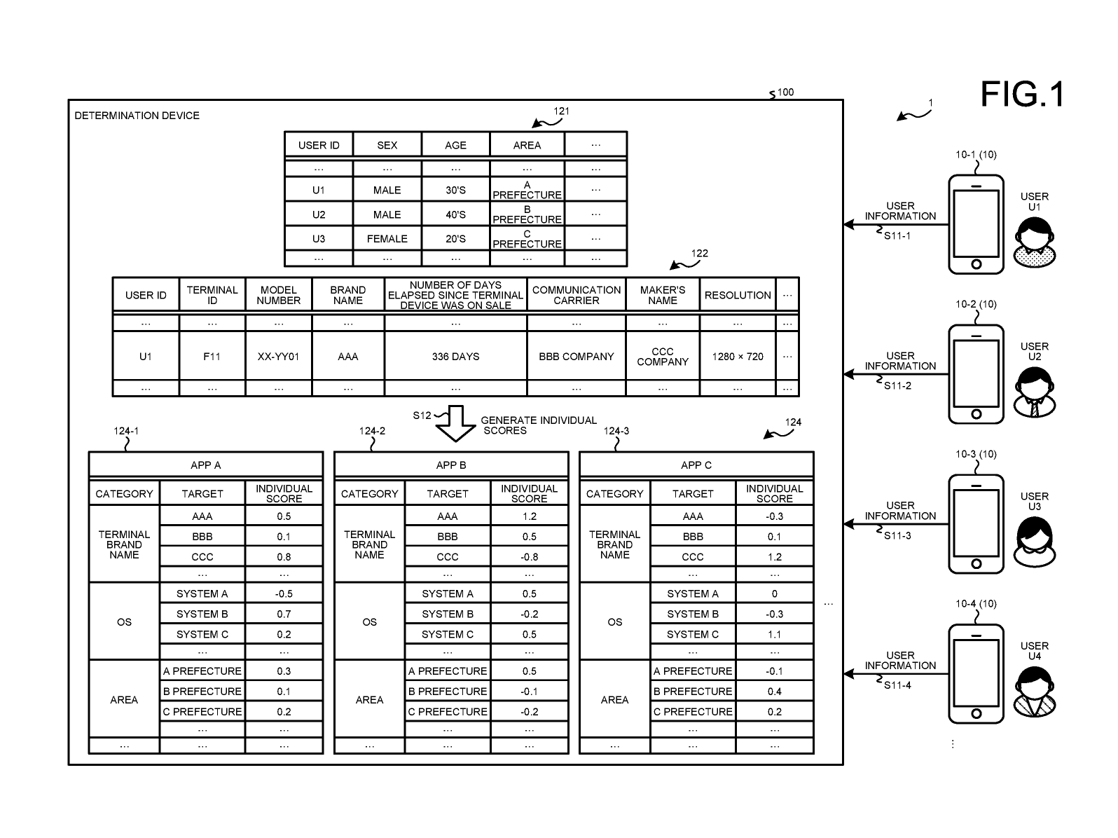

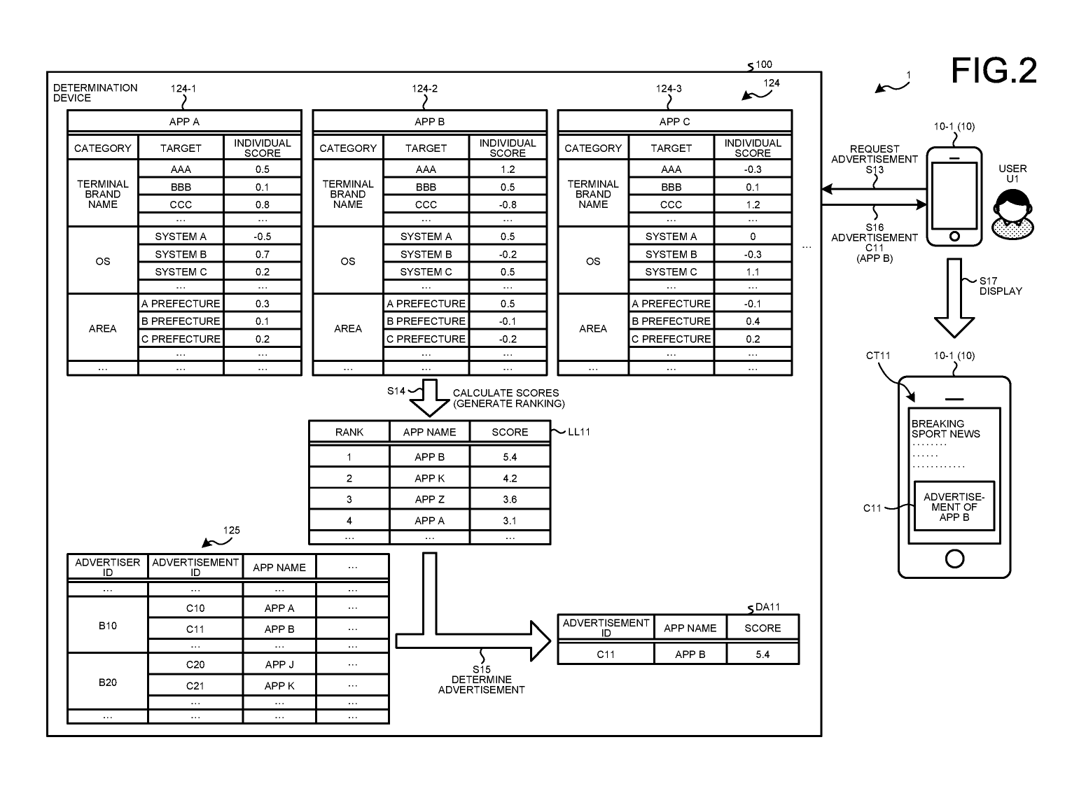

First, an example of determination processing according to an embodiment will be described using FIGS. 1 and 2. FIGS. 1 and 2 are diagrams illustrating an example of determination processing according to an embodiment. In the example illustrated in FIGS. 1 and 2, a case in which an application (hereinafter, simply referred to as “app”) is content, an advertisement of the app is distribution content, and installation of the app is a predetermined behavior will be described. That is, in FIGS. 1 and 2, a determination device 100 calculates a score regarding a probability of a user performing installation for each of a plurality of apps, and determines the advertisement of the app to be distributed to a terminal device on the basis of the calculated scores. Further, in the example illustrated in FIGS. 1 and 2, a case in which users U1 to U4 respectively use terminal devices 10-1 to 10-4 will be described. When description is given without distinguishing the terminal devices 10-1 to 10-4, these terminal devices are collectively referred to as terminal device 10.

As illustrated in FIGS. 1 and 2, a determination system 1 includes the terminal device 10 and the determination device 100. The terminal device 10 and the determination device 100 are communicatively connected by wired or wireless means through a predetermined communication network (not illustrated). Note that the determination system 1 illustrated in FIG. 1 may include a plurality of the terminal devices 10 and a plurality of the determination devices 100.

The terminal device 10 is an information processing device used by the user. The terminal device 10 is realized by a smart phone, a tablet-type terminal, a note-type personal computer (PC), a desktop PC, a mobile phone device, a personal digital assistant (PDA), or the like. FIGS. 1 and 2 illustrate a case in which the terminal device 10 is a smart phone.

Further, the terminal device 10 receives an operation by the user. In the example illustrated in FIG. 2, the terminal device 10 requests the determination device 100 of content to be displayed in a predetermined app (for example, a browser). Note that, hereinafter, the terminal device 10 may be described as user. That is, hereinafter, the user can be read as terminal device 10.

The determination device 100 is an information processing device that calculates the score regarding a probability of a user performing installation for each of the plurality of apps on the basis of user information. Further, the determination device 100 is an information processing device that determines the advertisement of the app to be distributed to the terminal device 10 on the basis of the scores of the apps. For example, the determination device 100 is an information processing device that distributes the determined advertisement of the app to the terminal device 10.

The determination device 100 collects the user information of the users from the terminal devices 10 of the users. Note that the user information referred to here may include any information as long as the information is related to the user. For example, the user information may include any information as long as the information is characteristic information indicating a characteristic of the user. For example, the user information may include various types of information such as information regarding demographic attributes of the user, information regarding psychographic attribute, and information regarding the terminal device 10 used by the user. Further, for example, the information regarding the terminal device 10 may include information regarding a specification of the terminal device 10, information regarding the app installed in the terminal device 10, and the like. Note that, hereinafter, an example in which the determination device 100 collects the user information of the users from the terminal devices 10 of the users will be described. However, the determination device 100 may acquire the user information of the users from an external device other than the terminal devices 10 of the users.

In the example of FIG. 1, the determination device 100 acquires the user information of the user U1 from the terminal device 10-1 (step S11-1). Further, the determination device 100 acquires the user information of the user U2 from the terminal device 10-2 (step S11-2). Further, the determination device 100 acquires the user information of the user U3 from the terminal device 10-3 (step S11-3). Further, the determination device 100 acquires the user information of the user U4 from the terminal device 10-4 (step S11-4).

Note that steps S11-1 to S11-4 are processes for describing the processing. Any of steps S11-1 to S11-4 may be performed first, and steps S11-1 to S11-4 may be performed a plurality of times. For example, steps S11 are performed a plurality of times at predetermined timing, so that the determination device 100 may acquire the user information of the users. Hereinafter, when description is given without distinguishing steps S11-1 to S11-4, these steps are collectively referred to as step S11. For example, steps S11 may be performed together with advertisement requests (see step S13 in FIG. 2) that are distribution requests of the advertisement from the corresponding terminal devices 10 of the users. For example, the determination device 100 may acquire the user information of the user U1 from the terminal device 10-1 when the advertisement request is made from the terminal device 10-1 of the user U1.

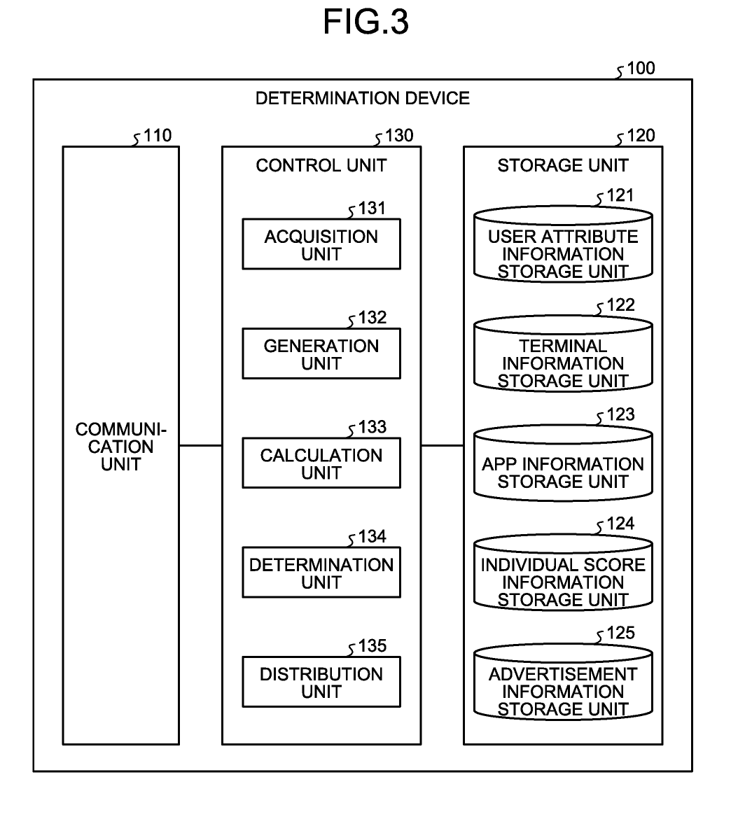

Then, the determination device 100 stores the user information of the users collected in step S11 to a storage unit 120 (see FIG. 3). Note that the user information stored to the storage unit 120 by the determination device 100 may be user information estimated from the user information of the users collected in step S11. For example, the determination device 100 may estimate a residential area of the user U1 on the basis of position information of the user U1 collected in step S11, and store the estimated residential area to a user attribute information storage unit 121.

In the example of FIG. 1, the determination device 100 stores information regarding user attributes of the users (hereinafter, also referred to as “user attribute information”) to the user attribute information storage unit 121. For example, the determination device 100 stores the user attribute information indicating that the sex of the user U1 is “male”, the age is “30's”, and the residential area is “A prefecture” to the user attribute information storage unit 121 on the basis of the user information collected in step S11.

Further, in the example of FIG. 1, the determination device 100 stores information regarding the terminal devices 10 used by the users (hereinafter, also referred to as “terminal information”) to a terminal information storage unit 122. For example, the determination device 100 stores the terminal information indicating that the model number is “XX-YY01”, the (terminal) brand name is “AAA”, the number of days elapsed since the terminal device was on sale is “336 days”, and the like about the terminal device 10-1 used by the user U1, to the terminal information storage unit 122, on the basis of the user information collected in step S11. For example, the determination device 100 may calculate the number of days elapsed since the terminal device was on sale on the basis of the model number and the like acquired from the terminal device 10. Further, for example, the determination device 100 may inquire of an external device about the model number and the like acquired from the terminal device 10, and acquire the number of days elapsed since the terminal device was on sale from the external device.

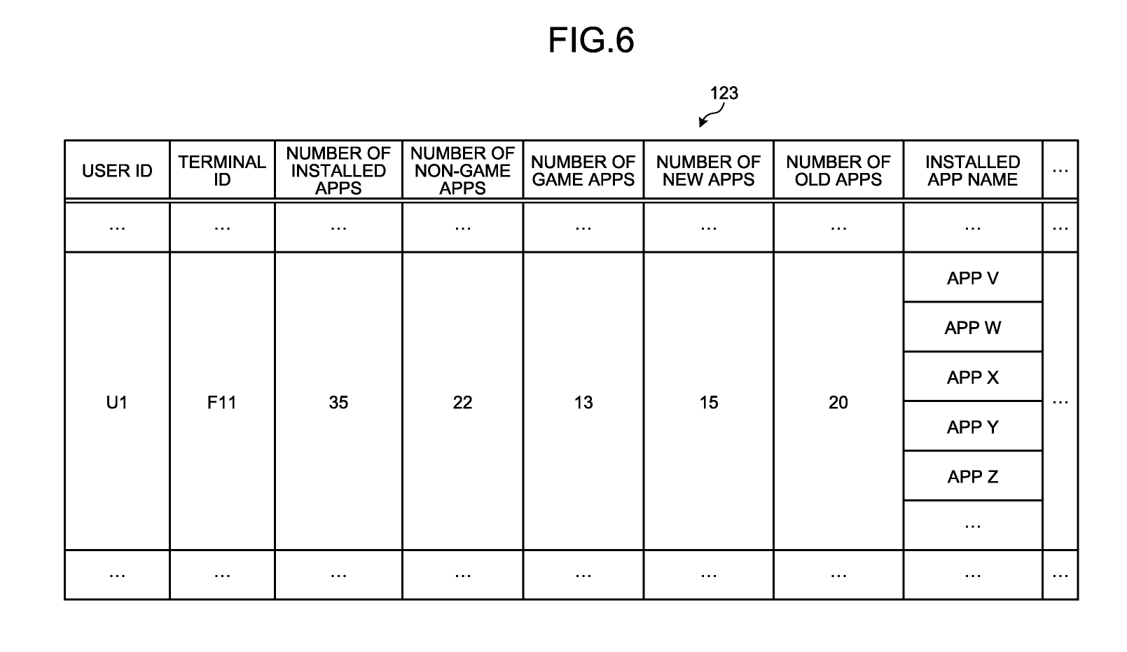

Although not illustrated, the determination device 100 collects, beyond the above-described information, various types of user information such as information regarding the app already installed in the terminal device 10 (see FIG. 6).

Then, the determination device 100 generates information regarding an individual score (may also be simply referred to as “individual score information” or “individual score”) on the basis of the user information acquired in step S11 (step S12). For example, the determination device 100 generates the individual score information for each app. In the example of FIG. 1, the determination device 100 generates the individual score information for each of an app A, an app B, an app C, and the like, and stores the individual score information to an individual score information storage unit 124. To be specific, the determination device 100 generates individual score information 124-1 regarding the app A, and stores the individual score information 124-1 to the individual score information storage unit 124. Further, the determination device 100 generates individual score information 124-2 regarding the app B, and stores the individual score information 124-2 to the individual score information storage unit 124. Further, the determination device 100 generates individual score information 124-3 regarding the app C, and stores the individual score information 124-3 to the individual score information storage unit 124.

Further, as illustrated in the individual score information storage unit 124 in FIG. 1, the determination device 100 generates the individual score information for each user information. For example, the determination device 100 generates the individual score information indicating that the individual score in a case where a category “terminal brand name” is “AAA” is “0.5”, the individual score in a case of “BBB” is “0.1”, and the individual score in a case of “CCC” is “0.8”, about the app A.

Further, the determination device 100 may generate the individual score information by learning, using the user information as features, weights of the features, that is, the individual scores. For example, the determination device 100 learns the weights (individual scores) of the features, using “AAA”, “BBB”, “CCC”, and the like in the category “terminal brand name”, or “system A”, “system B”, “system C”, and the like in a category “OS”, as features. For example, the determination device 100 learns the weights (individual scores) of the features, using “A prefecture”, “B prefecture”, “C prefecture”, and the like in a category “area”, as features.

For example, the determination device 100 may generate the individual score information regarding the apps, by leaning the weights (individual scores) of the features (user information), using the user information of the users who have installed the apps, of the user information collected in step S11, as positive examples. For example, the determination device 100 may generate the individual score information regarding the app A by leaning the weight (individual score) of the features (user information), using the user information of the users who have installed the app A, of the user information collected in step S11, as positive examples.

Further, for example, the determination device 100 may generate the individual score information regarding the apps by learning the weights (individual scores) of the features (user information), using the user information of the users who have not installed the apps, of the user information collected in step S11, as negative examples of the apps. For example, the determination device 100 may generate the individual score information regarding the app A by learning the weight (individual score) of the features (user information), using the user information of the users who have not installed the app A, of the user information collected in step S11, as negative examples.

For example, the determination device 100 may generate the individual score information regarding the apps by learning the weights (individual scores) of the features (user information), using the following formula (1).

yᵢ=ω₁·x₁+ω₂·x₂+ω₃·x₃ . . . ω_{N}·x_{N} (1)

“N” of “ω_{N}” and “x_{N}” in the right side in the above formula (1) represents an arbitrary number. Further, “i” of “yᵢ” in the left side of the above formula (1) represents which app is targeted. For example, “y₁” represents a phenomenon as to whether the app A is to be installed into the terminal device 10. In other words, “y₁” represents a probability of the app A being installed into the terminal device 10. Further, for example, “y₂” represents a phenomenon as to whether the app B is to be installed into the terminal device 10. For example, “i” of “yᵢ” in the left side of the above formula (1) corresponds to the number of apps, the scores of which are to be calculated.

Further, in the above formula (1), “x” corresponds to the user information (feature). For example, “x₁” in the above formula (1) corresponds to “AAA” in the category “terminal brand name”. Further, for example, “x₂” in the above formula (1) corresponds to “BBB” in the category “terminal brand name”, and “x₃” corresponds to “CCC” in the category “terminal brand name”. Further, in the above formula (1), “ω” represents a coefficient of “x”, and indicates the weight. For example, in the above formula (1), “ω₁” represents a weight value of “x₁”, “ω₂” is a weight value of “x₂”, and “ω₃” is a weight value of “x₃”.

Note that the above description is an example, and the determination device 100 may generate the individual score information by any method as long as the determination device 100 generates information regarding the individual scores on the basis of the user information.

Next, an example of determining the advertisement to be distributed to the terminal device 10 of the user, using the individual score information generated by the determination device 100, will be described using FIG. 2. FIG. 2 illustrates a case of determining the advertisement of the app to be distributed to the terminal device 10-1 used by the user U1.

First, the determination device 100 acquires the advertisement request from the terminal device 10-1 used by the user U1 (step S13). In FIG. 2, the terminal device 10-1 requests the determination device 100 of the advertisement displayed in content CT11.

The determination device 100, which has acquired the advertisement request from the terminal device 10-1, calculates the scores of the apps (step S14). For example, the determination device 100 calculates the score of the app A, the score of the app B, and the score of the app C about the user U1. To be specific, the determination device 100 calculates the score of the app A on the basis of the individual score information 124-1 regarding the app A and the user information of the user U1. Assume that, in the example of FIG. 2, the apps A, B, C, and the like have not been installed in the terminal device 10-1. Further, the determination device 100 may not include, to the target to which the advertisement is distributed, the app installed in the terminal device 10 that requests the advertisement. In this case, the determination device 100 may not calculate the score about the app installed in the terminal device 10 that requests the advertisement. For example, the determination device 100 may not calculate the score about the app B in a case where the app B has already been installed in the terminal device 10 that requests the advertisement.

In the example illustrated in FIG. 2, the terminal brand name of the user U1 is “AAA” (see FIG. 1), and thus the individual score “0.5” of “AAA” in the category “terminal brand name” in the individual score information 124-1 is added to the score of the app A. Further, in the example illustrated in FIG. 2, the residential area of the user U1 is “A prefecture” (see FIG. 1), and thus the individual score “0.3” of “A prefecture” in the category “area” in the individual score information 124-1 is added to the score of the app A. In this way, the determination device 100 calculates the score of the app A by adding up the individual scores corresponding to the user information of the user U1 in the individual score information 124-1.

In the example of FIG. 2, the determination device 100 calculates the score of the app A as “3.1 (=0.5+0.3+ . . . )”. Further, in the example of FIG. 2, the determination device 100 calculates the score of the app B as “5.4 (=1.2+0.5+ . . . )”, by adding the individual score “1.2” of “AAA” and the individual score “0.5” of “A prefecture” to the score of the app B on the basis of the individual score information 124-2, about the app B. In this way, the determination device 100 calculates the scores of the apps (apps A, B, C, and the like) by performing the above-described processing for the apps (apps A, B, C, and the like).

For example, the determination device 100 may calculate the scores of the apps, using the above formula (1). Note that the determination device 100 may calculate the scores of the apps, using the individual scores in any manner, as long as the determination device 100 can calculate the scores of the apps. For example, the determination device 100 may change the weights (individual scores) of the features (user information) on the basis of various types of information. For example, in a case where the determination device 100 has acquired information indicating a tendency for the user who installs a certain app to use the terminal device 10 of a specific terminal brand name “X”, the determination device 100 may make the weight (individual score) of the feature corresponding to the terminal brand name “X” large. That is, the determination device 100 may adjust the score of the app on the basis of the information regarding an affinity between the user and the app. Accordingly, the determination device 100 can appropriately calculate the scores of the apps even if the user information acquirable from the users is limited. Note that the determination device 100 may perform, in a case where normalization is required among the scores of the apps, the normalization of the scores of the apps, and then perform processing below on the basis of the scores after the normalization. In the case where the normalization is required among the scores of the apps, the determination device 100 may perform normalization of the individual scores of the user information about the apps.

Then, the determination device 100 generates a ranking of the apps on the basis of the calculated scores of the apps. In the example of FIG. 2, the determination device 100 generates ranking information LL11 of the apps on the basis of the calculated scores of the apps. For example, the determination device 100 generates the ranking information LL11 of the apps by ranking the calculated scores of the apps in descending order (hereinafter, the ranking may also be referred to as “rank”). To be specific, the determination device 100 generates the ranking information LL11 indicating that the app B is ranked “first”, an app K is ranked “second”, an app Z is ranked “third”, and the app A is ranked “fourth”.

Then, the determination device 100 determines the advertisement to be distributed to the terminal device 10-1 of the user U1 on the basis of the ranking information LL11 generated in step S14, and advertising information stored in an advertising information storage unit 125 (step S15). In the example of FIG. 2, the determination device 100 determines an advertisement C11 of the app B in the highest rank in the ranking information LL11 as the advertisement to be distributed to the terminal device 10-1 of the user U1, as illustrated in a distribution advertisement list DA11.

After that, the determination device 100 distributes the advertisement C11 of the app B to the terminal device 10-1 (step S16). Then, the terminal device 10-1 that has received the advertisement C11 of the app B displays the advertisement C11 of the app B (step S17). In FIG. 2, the terminal device 10-1 displays the advertisement C11 of the app B in the content CT11.

As described above, the determination device 100 calculates the scores regarding a probability of a user performing installation, for the plurality of apps, and determines the advertisement of the app to be distributed to the terminal device on the basis of the calculated scores. Accordingly, the determination device 100 can appropriately determine the content to be distributed to the terminal device. That is, the determination device 100 can distribute the advertisement of the app having a high probability of being installed by the user, to the terminal device 10 of the user, and thereby to improve an advertisement effect.

2. Configuration of Determination Device

Next, a configuration of the determination device 100 according to the embodiment will be described using FIG. 3. FIG. 3 is a diagram illustrating a configuration example of the determination device 100 according to an embodiment. As illustrated in FIG. 3, the determination device 100 includes a communication unit 110, a storage unit 120, and a control unit 130. Note that the determination device 100 may include an input unit (for example, a keyboard or a mouse) that receives various operations from an administrator or the like of the determination device 100, and a display unit (for example, a liquid crystal display) for displaying various types of information.

Communication Unit 110

The communication unit 110 is realized by a network interface card (NIC) and the like, for example. The communication unit 110 is connected with a network by wired or wireless means, and transmits/receives information to/from the terminal device 10.

Storage Unit 120

The storage unit 120 is realized by, for example, a random access memory (RAM), a semiconductor memory element such as a flash memory, or a storage device such as a hard disk or an optical disk. As illustrated in FIG. 3, the storage unit 120 according to the embodiment includes the user attribute information storage unit 121, the terminal information storage unit 122, an app information storage unit 123, the individual score information storage unit 124, and the advertising information storage unit 125.

User Attribute Information Storage Unit 121

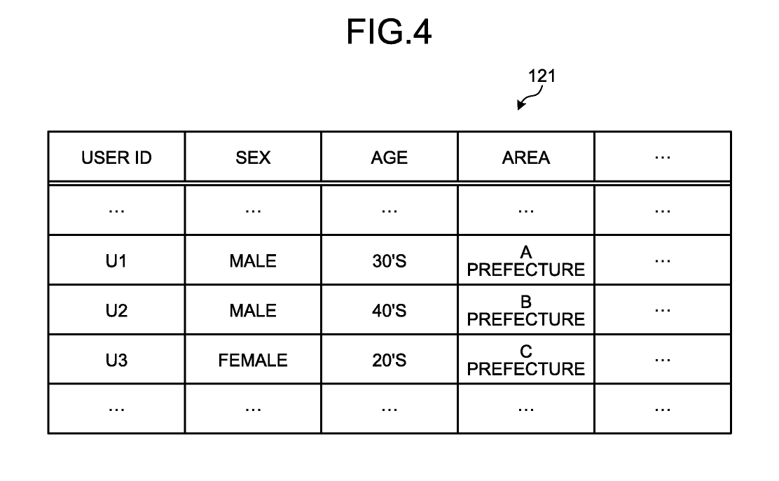

The user attribute information storage unit 121 according to the embodiment stores various type of information regarding the user attribute. For example, the user attribute information storage unit 121 stores the user attribute information. FIG. 4 is a diagram illustrating an example of a user attribute information storage unit according to an embodiment. The user attribute information storage unit 121 illustrated in FIG. 4 includes items such as a “user ID”, a “sex”, an “age”, and an “area”.

The “user ID” indicates identification information for identifying the user. For example, the user identified by a user ID “U1” corresponds to the user U1 illustrated in the example of FIG. 1. The “sex” indicates a sex of the user who uses the terminal device 10. The “age” indicates an age of the user who uses the terminal device 10. Note that the “age” may be a specific age of the user identified by the user ID, such as 35 years old, for example. The “area” indicates a residential area of the user who uses the terminal device 10. Note that, in the “area”, an area name that indicates a fixed range corresponding to the residential area of the user (Kanto region, for example), a country name, or the like may be stored, rather than a specific address.

For example, in the example illustrated in FIG. 4, the sex identified by the user ID “U1” is “male”, and the age of the user is “30's”. Further, for example, the user identified by the user ID “U1” indicates that the residential area is “A prefecture”.

Note that the user attribute information storage unit 121 may store various types of information according to intended use beyond the above-described information. For example, the user attribute information storage unit 121 may store information regarding demographic attributes of the user, information regarding psychographic attributes. For example, the user attribute information storage unit 121 may store information such as a name, a family makeup, an income, an interest, and a life style.

Terminal Information Storage Unit 122

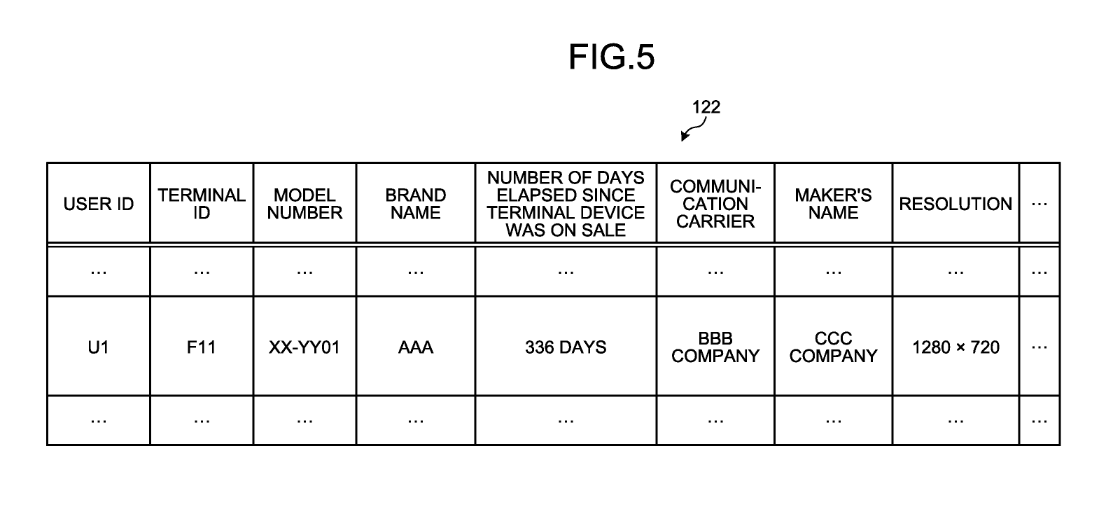

The terminal information storage unit 122 according to the embodiment stores various types of information regarding the terminal device used by the user. For example, the terminal information storage unit 122 stores the terminal device information. FIG. 5 is a diagram illustrating an example of a terminal information storage unit according to an embodiment. For example, the terminal information storage unit 122 stores behavior information of the user to content distributed to the terminal devices 10 of the users. The terminal information storage unit 122 illustrated in FIG. 5 includes items such as a “user ID”, a “terminal ID”, a “model number”, a “brand name”, the “number of days elapsed since the terminal device was on sale”, a “communication carrier”, a “maker's name”, and a “resolution”.

The “user ID” indicates identification information for identifying the user. The “terminal ID” is identification information for identifying the terminal device 10. For example, the terminal device 10 identified by a terminal ID “F11” corresponds to the terminal device 10-1 used by the user U1 illustrated in the example of FIG. 1. The “model number” indicates a model number of the terminal device 10. The “brand name” indicates a brand name provided to the terminal device 10. The “number of days elapsed since the terminal device was on sale” indicates the number of days elapsed since the terminal device 10 was on sale. The “communication carrier” indicates a name of a company of a communication carrier that provides communication line to the terminal device 10. The “resolution” indicates a resolution of a screen of the terminal device 10.

For example, in the example illustrated in FIG. 5, the terminal device 10 identified by the terminal ID “F11” indicates that the model number is “XX-YY01” and the brand name is “AAA”. Further, the terminal device 10 identified by the terminal ID “F11” indicates that “336 days” have passed after sale, the communication carrier is “BBB company”, the manufacture that manufactures the terminal device 10 is “CCC company”, and the resolution is “1280×720”. Note that the terminal information storage unit 122 may store various types of information according to intended use beyond the above-described information.

App Information Storage Unit 123

The app information storage unit 123 according to the embodiment stores various types of information regarding the app. For example, the app information storage unit 123 stores information regarding the app installed in the terminal device 10. FIG. 6 is a diagram illustrating an example of an app information storage unit according to an embodiment. The app information storage unit 123 illustrated in FIG. 6 includes items such as a “user ID”, a “terminal ID”, the “number of installed apps”, the “number of non-game apps, the “number of game apps”, the “number of new apps”, the “number of old apps”, a “name of installed app”.

The “user ID” indicates identification information for identifying the user. The “terminal ID” is identification information for identifying the terminal device 10. The “number of installed apps” indicates the total number of apps installed in the terminal device 10. The “number of non-game apps” indicates the number of apps other than game apps, of the installed apps. The “number of game apps” indicates the number of game apps, of the installed apps. The “number of new apps” indicates the number of apps that are relatively recently provided (for example, within one year), of the installed apps. The “number of old apps” indicates the number of apps other than the new apps, of the installed apps. The “name of installed app” indicates the app installed in the terminal device 10.

For example, in the example illustrated in FIG. 6, the terminal device 10 identified by the terminal ID “F11” indicates that “35” apps have been installed. Further, the terminal device 10 identified by the terminal ID “F11” indicates that the number of non-game apps is “22” and the number of game apps is “13”, of the installed apps. Further, the terminal device 10 identified by the terminal ID “F11” indicates that the number of new apps is “15” and the number of old apps is “20”, of the installed apps. Further, the terminal device 10 identified by the terminal ID “F11” indicates that the installed apps are an “app V”, an “app W”, an “app X”, an “app Y”, an “app Z”, and the like. Note that the “name of installed app” may store identification information for identifying the app. Note that the app information storage unit 123 may store various types of information according to intended use beyond the above-described information.

Individual Score Information Storage Unit 124

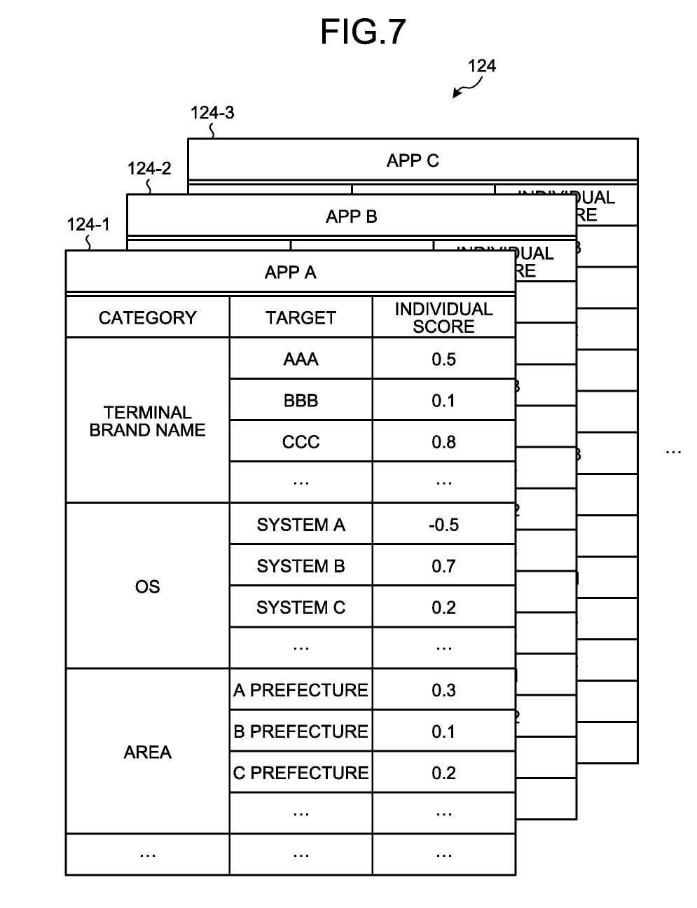

The individual score information storage unit 124 according to the embodiment stores the individual score information regarding the apps. For example, the individual score information storage unit 124 stores the individual score information regarding the apps generated from the user information. FIG. 7 is a diagram illustrating an example of an individual score information storage unit according to an embodiment. The individual score information storage unit 124 illustrated in FIG. 7 includes the individual score information 124-1 regarding the app A, the individual score information 124-2 regarding the app B, the individual score information 124-3 regarding the app C, and the like. The individual score information 124-1 to 124-3 includes items such as a “category”, a “target”, and an “individual score”.

The “category” indicates a category of the user information. The “target” indicates a specific target corresponding to the category, that is, a target of which the individual score is generated. The “individual score” indicates the individual score of the targets (user information).

For example, in FIG. 7, as illustrated in individual score information 124-1, the individual score information about the app A is generated, which indicates that the individual score in a case where the category “area” is “A prefecture” is “0.3”, the individual score in a case of “B prefecture” is “0.1”, and the individual score in a case of “C prefecture” is “0.2”. Note that the individual score information storage unit 124 may store various types of individual score information according to intended use beyond the above-described information.

Advertising Information Storage Unit 125

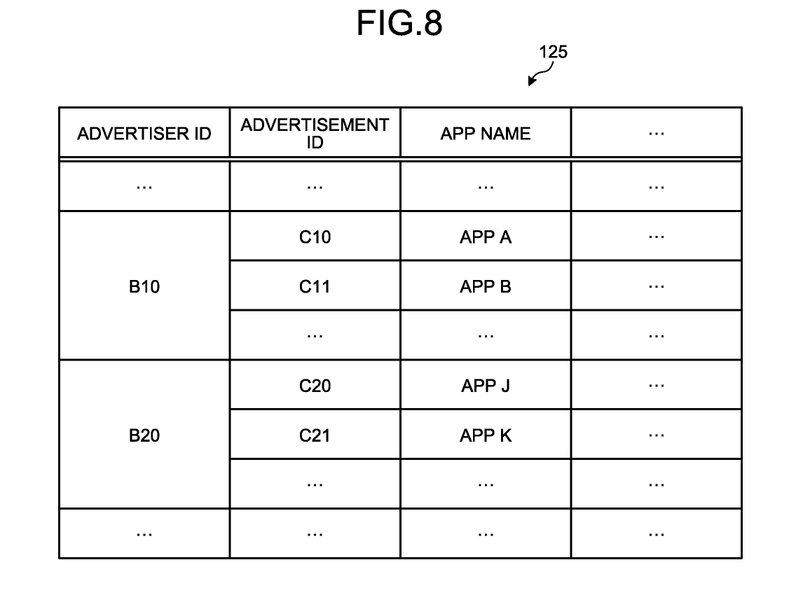

The advertising information storage unit 125 according to the embodiment stores various types of information regarding the advertisement. For example, the advertising information storage unit 125 stores various types of information regarding the advertisement mainly submitted by an advertiser. Note that the “advertiser” referred to here is a concept including not only the advertiser but also an advertising agency. FIG. 8 is a diagram illustrating an example of an advertising information storage unit according to an embodiment. The advertising information storage unit 125 illustrated in FIG. 8 includes items such as an “advertiser ID”, an “advertisement ID”, and an “app name”.

The “advertiser ID” indicates identification information for identifying the advertiser. The “advertisement ID” indicates identification information for identifying the advertisement submitted by the advertiser. The “app name” indicates the app corresponding to the advertisement. For example, the advertisement identified by an advertisement ID “C10” may be described as “advertisement C10”. Note that the app may be associated with a plurality of advertisements, instead of being associated with the advertisement on a one-on-one basis.

Further, the advertising information storage unit 125 may store information regarding various advertisements according to intended use beyond the above-described information. For example, the advertising information storage unit 125 may store a condition of a distribution destination specified for each advertisement, the number of distribution (a specified impression number) specified for each advertisement, and the like. Further, the advertising information storage unit 125 may store an index value that indicates the advertisement effect. For example, the advertising information storage unit 125 may store the index values such as a cost per install (CPI) and a click through rate (CTR) for each advertisement.

Further, the advertising information storage unit 125 may store information regarding rates of the advertisements, for example, tender prices (hereinafter, also referred to as “bid prices”). Further, the advertising information storage unit 125 may store information regarding stock such as quantities in stock of the advertisements. Further, the advertising information storage unit 125 may store information regarding categories of the advertisements.

Control Unit 130

Referring back to the description of FIG. 3, the control unit 130 is a controller, and is realized by, for example, the various programs (corresponding to an example of distribution programs) stored in the storage device inside the determination device 100 being executed by a central processing unit (CPU) or a micro processing unit (MPU), using the RAM as a work area. Further, the control unit 130 is a controller, and is realized by, for example, an integrated circuit such as an application specific integrated circuit (ASIC) or a field programmable gate array (FPGA).

As illustrated in FIG. 3, the control unit 130 includes an acquisition unit 131, a generation unit 132, a calculation unit 133, a determination unit 134, and a distribution unit 135, and realizes or executes functions and actions of information processing described below. Note that the internal configuration of the control unit 130 is not limited to the configuration illustrated in FIG. 3, and another configuration may be employed as long as the configuration performs the information processing described below. Further, connection relationship among the processing units included in the control unit 130 is not limited to that illustrated in FIG. 3, and another connection relationship may be employed.

Acquisition Unit 131

The acquisition unit 131 acquires various types of information. For example, the acquisition unit 131 acquires the user information that is the information regarding the user who uses the terminal device 10 that becomes a providing destination of content. For example, the acquisition unit 131 acquires the user information regarding the user who uses the terminal device 10 that becomes the providing destination of an application. For example, the acquisition unit 131 acquires the user attribute information. For example, the acquisition unit 131 acquires the terminal information regarding the terminal device 10 used by the user. For example, the acquisition unit 131 acquires the app information. Further, the acquisition unit 131 acquires the advertisement request from the terminal device 10.

Generation Unit 132

The generation unit 132 generates the individual score information on the basis of the user information. For example, the generation unit 132 generates the individual score information for each app. In the example of FIG. 1, the generation unit 132 generates the individual score information for each of the app A, the app B, the app C, and the like. To be specific, the generation unit 132 generates the individual score information 124-1 regarding the app A. Further, the generation unit 132 generates the individual score information 124-2 regarding the app B. Further, the generation unit 132 generates the individual score information 124-3 regarding the app C.

Further, the generation unit 132 generates the individual score information for each user information. For example, the generation unit 132 generates the individual score information indicating that the individual score in a case where the category “terminal brand name” is “AAA” is “0.5”, the individual score in a case of “BBB” is “0.1”, and the individual score in a case of “CCC” is “0.8” about the app A.

Further, the generation unit 132 may generate the individual score information by learning the weights of the features, that is, the individual scores, using the user information as features. For example, the generation unit 132 generates the individual score information regarding the apps by learning the weights (individual scores) of the features (user information), using the user information of the users who have installed the apps, of the user information collected in step S11, as positive examples of the apps. For example, the generation unit 132 generates the individual score information regarding the app A by learning the weights (individual scores) of the features (user information), using the user information of the users who have installed the app A, of the user information collected in step S11, as positive examples.

Further, for example, the generation unit 132 may generate the individual score information regarding the apps by learning the weights (individual scores) of the features (user information), using the user information of the users who have not installed the apps, of the user information collected in the step S11, as negative examples of the apps. For example, the generation unit 132 may generate the individual score information regarding the app A by learning the weights (individual scores) of the features (user information), using the user information of the users who have not installed the app A, of the user information collected in step S11, as negative examples. Note that the generation unit 132 may generate the individual score information by any method as long as the generation unit 132 generates the information regarding the individual scores on the basis of the user information.

Further, for example, the generation unit 132 may generate information regarding the ranking (rank) of the apps on the basis of the scores of the apps calculated by the calculation unit 133. In the example of FIG. 2, the generation unit 132 generates the ranking information LL11 of the apps on the basis of the scores of the apps calculated by the calculation unit 133.

Calculation Unit 133

The calculation unit 133 calculates a score regarding a probability of the user performing a predetermined behavior for each of a plurality of pieces of content on the basis of the user information acquired by the acquisition unit 131. The calculation unit 133 calculates the score of each of the plurality of pieces of content on the basis of the individual score generated for each user information. The calculation unit 133 calculates the score of each of the plurality of pieces of content on the basis of the individual score generated for each user information including the user attribute information. The calculation unit 133 calculates the score of each of the plurality of pieces of content on the basis of the individual score generated for each user information including the terminal information.

Further, the calculation unit 133 calculates the score regarding a probability of a user performing installation for each of a plurality of applications that is the plurality of pieces of content. For example, the calculation unit 133 calculates the scores of the apps. The calculation unit 133 calculates the scores of the apps on the basis of the individual score information and the user information. For example, the calculation unit 133 may calculate the scores of the apps, using the above formula (1). For example, the calculation unit 133 calculates the score of the app A, the score of the app B, the score of the app C, and the like. In the example of FIG. 2, the calculation unit 133 calculates the score of the app A about the user U1 on the basis of the individual score information 124-1 regarding the app A and the user information of the user U1. In the example illustrated in FIG. 2, since the terminal brand name of the user U1 is “AAA, the calculation unit 133 adds the individual score “0.5” of “AAA” in the category “terminal brand name” in the individual score information 124-1 to the score of the app A. Further, in the example illustrated in FIG. 2, since the residential area of the user U1 is “A prefecture”, the calculation unit 133 adds the individual score “0.3” of “A prefecture” in the category “area” in the individual score information 124-1 to the score of the app A. The calculation unit 133 calculates the score of the app A by adding up the individual scores corresponding to the user information of the user U1 in the individual score information 124-1. In the example of FIG. 2, the calculation unit 133 calculates the score of the app A as “3.1 (=0.5+0.3+ . . . )”. The calculation unit 133 calculates the scores of the apps (apps A, B, C, and the like) by performing the above processing for the apps (apps A, B, C, and the like).

Determination Unit 134

The determination unit 134 determines the distribution content to be distributed to the terminal device 10 on the basis of the scores of the pieces of content calculated by the calculation unit 133. The determination unit 134 determines the distribution content to be distributed to the terminal device 10, of the plurality of applications, on the basis of the scores of the applications calculated by the calculation unit 133. The determination unit 134 determines the advertisement of the application to be distributed to the terminal device 10 on the basis of the ranking of the applications according to the scores of the applications.

In the example of FIG. 2, the determination unit 134 determines advertisement to be distributed to the terminal device 10-1 of the user U1 on the basis of the ranking information LL11 and the advertising information stored in the advertising information storage unit 125. For example, the determination unit 134 determines the advertisement C11 of the app B in the highest rank in the ranking information LL11 as the advertisement to be distributed to the terminal device 10-1 of the user U1.

Further, for example, the determination unit 134 determines the advertisement of the application to be distributed to the terminal device 10 on the basis of the ranking varied according to the information regarding prices of the applications in advertisement distribution. For example, the determination unit 134 determines the advertisement of the application to be distributed to the terminal device 10 on the basis of the ranking varied according to the bid prices of the advertisements of the apps. Further, for example, the determination unit 134 determines the advertisement of the application to be distributed to the terminal device 10 on the basis of the ranking varied according to the information regarding the stock of the advertisements of the applications. Further, for example, the determination unit 134 determines the advertisement of the application to be distributed to the terminal device 10 on the basis of the ranking varied according to times to distribute the advertisements. Further, for example, the determination unit 134 determines the advertisement of the application to be distributed to the terminal device 10 on the basis of the ranking varied according to information regarding a user operation to the advertisements of the applications. For example, the determination unit 134 determines the advertisement of the application to be distributed to the terminal device 10 on the basis of the ranking varied according to a click through rate of the advertisements of the apps. Further, for example, the determination unit 134 determines the advertisement of the application to be distributed to the terminal device 10 on the basis of the ranking varied according to the content including an advertisement display area where the advertisement is displayed. Note that details of these points will be described below.

Further, the determination unit 134 may determine the distribution content to be distributed to the terminal device 10 on the basis of the degree of rarity of the user to one piece of content, the degree of rarity being calculated on the basis of the score of the one piece of content in the user who uses the terminal device 10, and the score of the one piece of content in another user. For example, the determination unit 134 may determine the distribution content to be distributed to the terminal device 10 on the basis of the degree of rarity of the user to one piece of content, the degree of rarity being calculated on the basis of a difference between the score of the one piece of content in the user who uses the terminal device 10, and an average of the scores of the one piece of content in the plurality of users. Note that details of this point will be described below.

Distribution Unit 135

The distribution unit 135 distributes various types of information to the terminal device 10. For example, the distribution unit 135 distributes the advertisement to the terminal device 10. Further, the distribution unit 135 distributes the advertisement determined by the determination unit 134. In FIG. 2, the distribution unit 135 distributes the advertisement C11 of the app B to the terminal device 10-1. Note that the distribution unit 135 may distribute the content CT11 to the terminal device 10-1.

3. Flow of Determination Processing

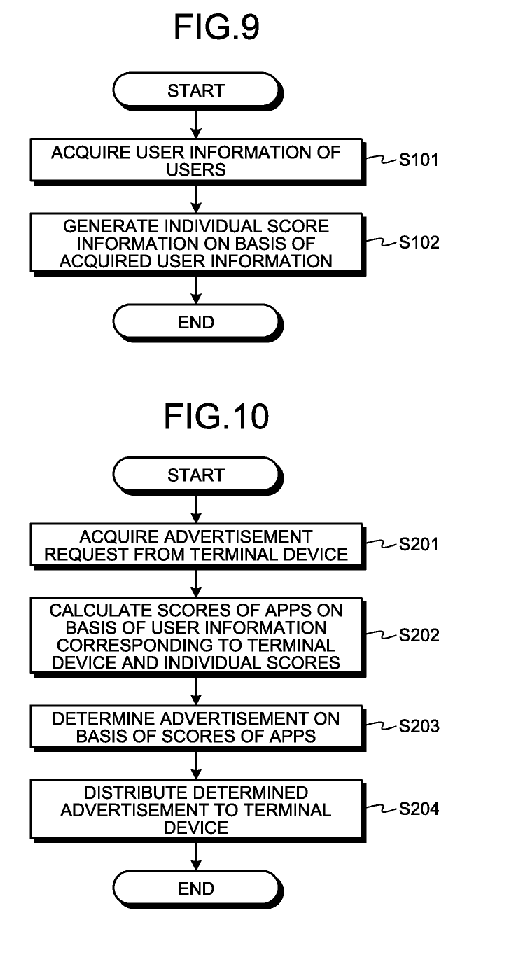

Next, a procedure of the determination processing by the determination system 1 according to the embodiment will be described using FIG. 9. FIG. 9 is a flowchart illustrating an example of determination processing according to an embodiment. To be specific, FIG. 9 is a flowchart illustrating an example of the determination processing regarding generation of the individual score information.

As illustrated in FIG. 9, the acquisition unit 131 of the determination device 100 acquires the user information of the users (step S101). For example, the acquisition unit 131 acquires the user information of the users from the terminal devices 10 used by the users.

Further, the generation unit 132 of the determination device 100 generates the individual score information on the basis of the acquired user information (step S102). For example, the generation unit 132 generates the individual score information for each app.

Next, a procedure of the determination processing by the determination system 1 according to the embodiment will be described using FIG. 10. FIG. 10 is a flowchart illustrating an example of determination processing according to an embodiment. To be specific, FIG. 10 is a flowchart illustrating an example of the determination processing, using the individual scores.

As illustrated in FIG. 10, the acquisition unit 131 of the determination device 100 acquires the advertisement request from the terminal device 10 (step S201). After that, the calculation unit 133 of the determination device 100 calculates the scores of the apps on the basis of the user information corresponding to the terminal device 10 and the individual scores (step S202). For example, the calculation unit 133 calculates the score of the app A about the user U1 on the basis of the individual score information 124-1 regarding the app A and the user information of the user U1.

After that, the determination unit 134 of the determination device 100 determines the advertisement on the basis of the scores of the apps (step S203). For example, the determination unit 134 determines that the advertisement C11 of the app B in the highest rank in the ranking information LL11 as the advertisement to be distributed to the terminal device 10-1 of the user U1.

After that, the distribution unit 135 of the determination device 100 distributes the determined advertisement to the terminal device 10 (step S204). For example, the distribution unit 135 distributes the advertisement C11 of the app B to the terminal device 10-1.

4. Change of Ranking

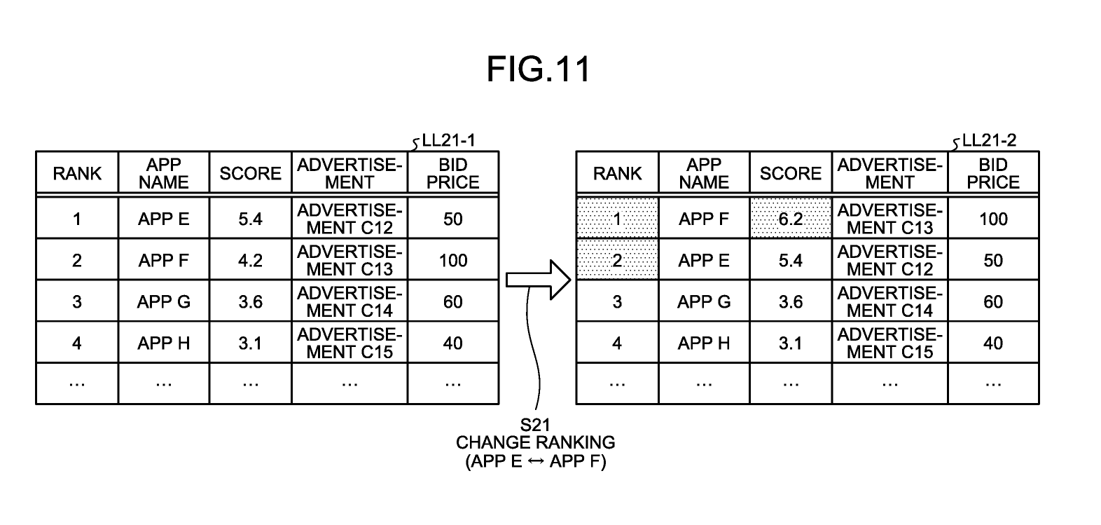

In the above-described example, an example of generating the ranking, using the scores calculated on the basis of the individual scores has been described. However, the ranking may be varied according to another information. This point will be described using FIGS. 11 to 15. FIGS. 11 to 15 are diagrams illustrating an example of ranking change according to an embodiment.

4-1. Change of Ranking Based on Bid Price

First, a case of varying the ranking according to the information regarding the prices of the apps in the advertisement distribution will be described using FIG. 11. The example of FIG. 11 illustrates a case in which the determination device 100 changes the ranking, using the bid prices of the advertisements of the apps as the information regarding the prices of the apps in the advertisement distribution.

Ranking information LL21-1 illustrated in FIG. 11 indicates ranking information before the ranking is changed. The ranking information LL21-1 indicates a case in which an app E having the largest score is ranked “first”, an app F having the next largest score to the app E is ranked “second”, an app G having the next largest score to the app F is ranked “third”, and an app H having the next largest score to the app G is ranked “fourth”. Further, the ranking information LL21-1 indicates a case in which the advertisement of the app E is “advertisement C12”, the advertisement of the app F is “advertisement C13”, the advertisement of the app G is “advertisement C14”, and the advertisement of the app H is “advertisement C15”.

Further, the ranking information LL21-1 indicates a case in which the bid price of the advertisement of the app E is “50”, the bid price of the advertisement of the app F is “100”, the bid price of the advertisement of the app G is “60”, and the bid price of the advertisement of the app H is “40”. Note that the information regarding the bid prices of the advertisements may be stored in the advertising information storage unit 125.

Here, the determination device 100 changes the ranking on the basis of the information regarding the bid prices of the advertisements (step S21). For example, the determination device 100 generates ranking information LL21-2 by changing the ranking indicated in the ranking information LL21-1 on the basis of the information regarding the bid prices of the advertisements.

In the example of FIG. 11, the bid price of the advertisement of the app F ranked second is larger than the bid price of the advertisement of the app E ranked first. Therefore, the determination device 100 changes the score of the advertisement of the app F ranked second. To be specific, the determination device 100 increases the score of the advertisement of the app F ranked second by “2”. Accordingly, the score of the advertisement of the app F ranked second becomes “6.2”, and becomes larger than “5.4” of the advertisement of the app E ranked first. Therefore, the determination device 100 switches the rank of the advertisement of the app E and the rank of the advertisement of the app F, as illustrated in the ranking information LL21-2. To be specific, the determination device 100 changes the ranking by causing the advertisement of the app E to be ranked “second”, and the advertisement of the app F to be ranked “first”. In this case, the determination device 100 distributes the advertisement of the app F ranked “first” in distributing one advertisement on the basis of the ranking.

Note that, in FIG. 11, an example of changing the score of the advertisement of the app F ranked “second” has been illustrated for simplification of description. However, the score of the advertisement of the app G having a higher bid price than the app E ranked first may be changed. For example, the determination device 100 may increase the score of the advertisement of the app G ranked “third” by “1”. In this case, the determination device 100 increases the score of the advertisement of the app H by “1” that is smaller than the increase “2” of the score of the advertisement of the app F because the app G is ranked lower than the app F, and the bid price is “60”, which is small. In this way, the determination device 100 may vary the score according to the bid prices and the ranks.

Further, FIG. 11 illustrates a case in which the score of the advertisement of the app F becomes “6.2” due to the increase in the score by “2”, and the rank is changed to “first”. However, the determination device 100 may change the ranking by any method. For example, the determination device 100 may switch the first advertisement and the second advertisement in a case where the bid price of the second advertisement is larger than the bid price of the first advertisement, and a difference in the score of the first advertisement and the score of the second advertisement is within a predetermined threshold. For example, the determination device 100 may switch the first advertisement and the second advertisement in a case where the bid price of the second advertisement is larger than the bid price of the first advertisement by a predetermined threshold or more. Further, in the above-described example, a case of switching the first advertisement and the second advertisement has been described. However, the determination device 100 may switch the first advertisement and the third advertisement.

Further, for example, in a case of selecting a plurality of the advertisements, the determination device 100 may switch the second advertisement and the third advertisement. For example, in a case of distributing two advertisements, the determination device 100 distributes the first advertisement and the second advertisement, which is switched from third.

4-2. Change of Ranking Based on Quantities in Stock

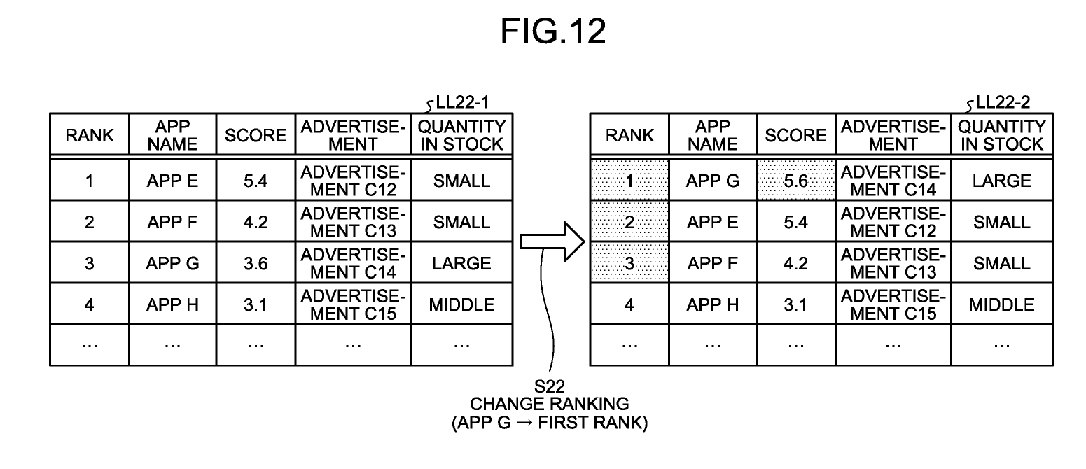

Next, a case of varying the ranking according to the information regarding the stock of the advertisements of the apps will be described using FIG. 12. FIG. 12 illustrates a case in which the determination device 100 changes the ranking, using quantities in stock of the advertisements of the apps as the information regarding the stock of the advertisements of the apps. Note that description of similar points to the example illustrated in FIG. 11 is appropriately omitted.

Ranking information LL22-1 illustrated in FIG. 12 indicates that the quantity in stock of the advertisement of the app E is “small”, the quantity in stock of the advertisement of the app F is “small”, the quantity in stock of the advertisement of the app G is “large”, and the quantity in stock of the advertisement of the app H is “middle”. Note that the information regarding the quantities in stock of the advertisements may be stored in the advertising information storage unit 125. Further, in the example illustrated in FIG. 12, the quantities in stock of the advertisements are conceptually illustrated as “large”, “middle”, and “small”. However, the quantities in stock of the advertisements may be numerical values that indicate specific quantities in stock. Further, in the example illustrated in FIG. 12, the quantities in stock having the quantity in stock “large” are largest, the quantities in stock having the quantity in stock “middle” are second largest next to the quantity in stock “large”, and the quantities in stock having the quantity in stock “small” are small.

Here, the determination device 100 changes the ranking on the basis of the information regarding the quantities in stock of the advertisements (step S22). For example, the determination device 100 generates ranking information LL22-2 by changing the ranking illustrated in the ranking information LL22-1 on the basis of the information regarding the quantities in stock of the advertisements.

In the example of FIG. 12, the quantity in stock of the advertisement of the app G ranked third is larger than the quantity in stock of the advertisement of the app E ranked first and the quantity in stock of the advertisement of the app F ranked second. Therefore, the determination device 100 changes the score of the advertisement of the app G ranked third. To be specific, the determination device 100 increases the score of the advertisement of the app G ranked third by “2”. Accordingly, the score of the advertisement of the app G ranked third becomes “5.6”, and becomes larger than the score “5.4” of the advertisement of the app E ranked first and the score “4.2” of the advertisement of the app F ranked second. Therefore, the determination device 100 switches the rank of the advertisement of the app E, the rank of the advertisement of the app F, and the rank of the advertisement of the app G, as illustrated in the ranking information LL22-2. To be specific, the determination device 100 changes the ranking by causing the advertisement of the app G to be ranked “first”, the advertisement of the app E to be ranked “second”, and the advertisement of the app F to be ranked “third”. In this case, the determination device 100 distributes the advertisement of the app G ranked “first” in distributing one advertisement on the basis of the ranking.

4-3. Change of Ranking Based on Distribution Time

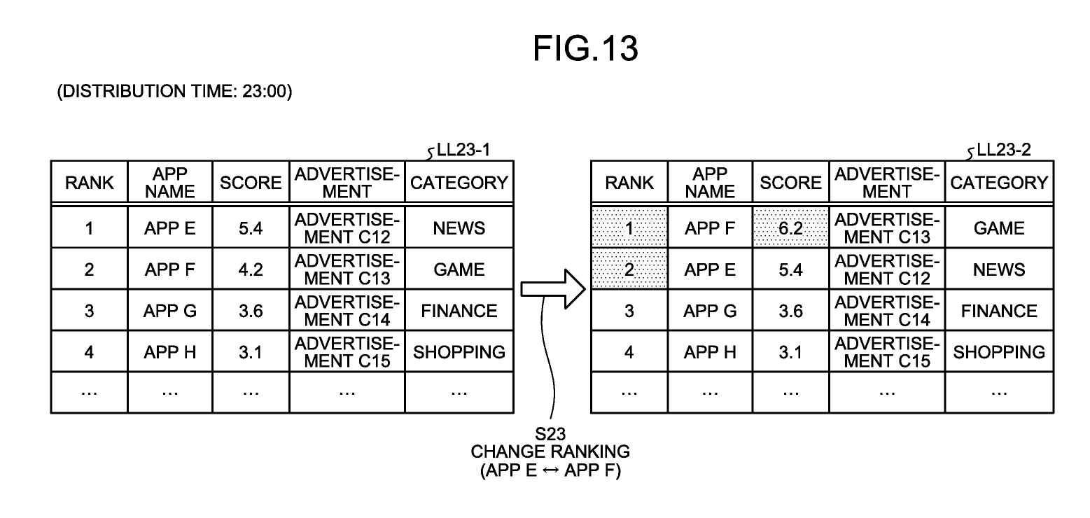

Next, a case of varying the ranking according to information regarding times to distribute the advertisements will be described using FIG. 13. In the example of FIG. 13, a case in which the determination device 100 changes the ranking, using information regarding distribution times of the advertisements will be described. Note that description of similar points to the example illustrated in FIGS. 11 and 12 is appropriately omitted.

Ranking information LL23-1 illustrated in FIG. 13 indicates a case in which the category of the advertisement of the app E is “news”, the category of the advertisement of the app F is “game”, the category of the advertisement of the app G is “finance”, and the category of the advertisement of the app H is “shopping”. Note that information regarding the categories of the advertisements may be stored in the advertising information storage unit 125.

Here, the determination device 100 changes the ranking on the basis of the information regarding the distribution times of the advertisements (step S23). For example, the determination device 100 generates ranking information LL23-2 by changing the ranking indicated in the ranking information LL23-1 on the basis of the information regarding the distribution times of the advertisements.

In the example of FIG. 13, assume that the distribution time of the advertisement is 23:00. Further, the determination device 100 acquires information indicating that the probability of the app of the category “game” being installed is higher than other apps in a late-night time zone. In this case, the determination device 100 changes the score of the advertisement of the app F of the category “game”. To be specific, the determination device 100 increases the score of the advertisement of the app F ranked second by “2”. Accordingly, the score of the advertisement of the app F ranked second becomes “6.2”, and becomes larger than the score “5.4” of the advertisement of the app E ranked first. Therefore, the determination device 100 switches the rank of the advertisement of the app E and the rank of the advertisement of the app F, as illustrated in the ranking information LL23-2. To be specific, the determination device 100 changes the ranking by causing the advertisement of the app E to be ranked “second” and the advertisement of the app F to be ranked “first”. In this case, the determination device 100 distributes the advertisement of the app F ranked “first” in distributing one advertisement on the basis of the ranking.

4-4. Change of Ranking Based on CTR

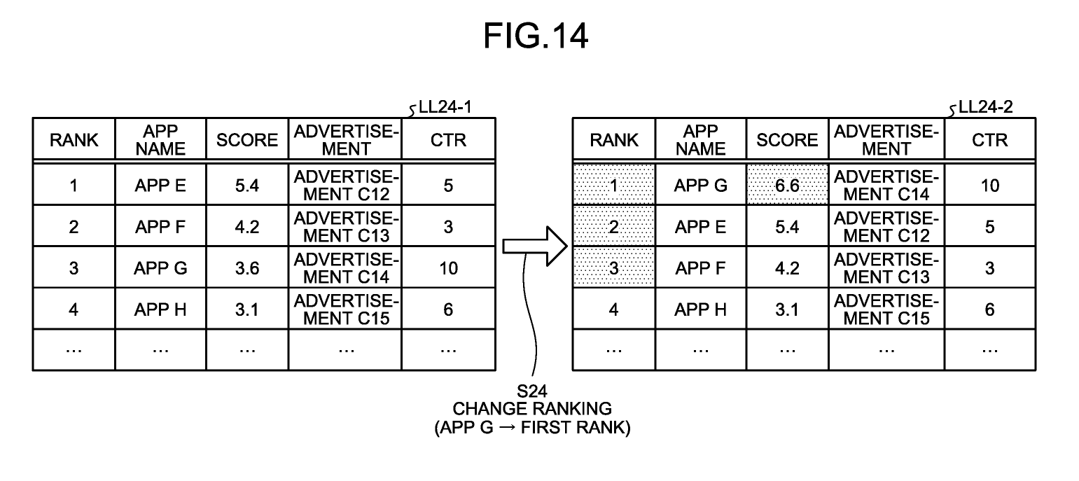

Next, a case of varying the ranking according to the information regarding a user operation to the advertisements of the apps will be described using FIG. 14. In the example of FIG. 14, a case in which the determination device 100 changes the ranking, using a click through rate (CTR) of the advertisements of the apps, as the information regarding the user operation to the advertisements of the apps will be described. Note that description of similar points to the examples illustrated in FIGS. 11 to 13 is appropriately omitted.

Ranking information LL24-1 in FIG. 14 illustrates a case in which the CTR of the advertisement of the app E is “5”, the CTR of the advertisement of the app F is “3”, the CTR of the advertisement of the app G is “10”, and the CTR of the advertisement of the app H is “6”. The CTRs of the advertisements illustrated in FIG. 14 are expressed in percentage. Note that the information regarding the user operation to the advertisements of the apps may be stored in the advertising information storage unit 125.

Here, the determination device 100 changes the ranking on the basis of the information regarding user operation to the advertisements of the apps (step S24). For example, the determination device 100 generates ranking information LL24-2 by changing the ranking indicated in the ranking information LL24-1 on the basis of the CTRs of the advertisement of the apps.

In the example of FIG. 14, the CTR of the advertisement of the app G ranked third is larger than the CTR of the apps E ranked first and the CTR of the advertisement of the app F ranked second. Therefore, the determination device 100 changes the score of the advertisement of the app G ranked third. To be specific, the determination device 100 increases the score of the advertisement of the app G ranked third by “3”. Accordingly, the score of the advertisement of the app G ranked third becomes “6.6”, and becomes larger than the score “5.4” of the advertisement of the app E ranked first and the score “4.2” of the advertisement of the app F ranked second. Therefore, the determination device 100 switches the rank of the advertisement of the app E, the rank of the advertisement of the app F, and the rank of the advertisement of the app G, as illustrated in the ranking information LL24-2. To be specific, the determination device 100 changes the ranking by causing the advertisement of the app G to be ranked “first”, the advertisement of the app E to be ranked “second”, and the advertisement of the app F to be ranked “third”. In this case, the determination device 100 distributes the advertisement of the app G ranked “first” in distributing one advertisement on the basis of the ranking.

4-5. Change of Ranking Based on Content where Advertisement is Displayed

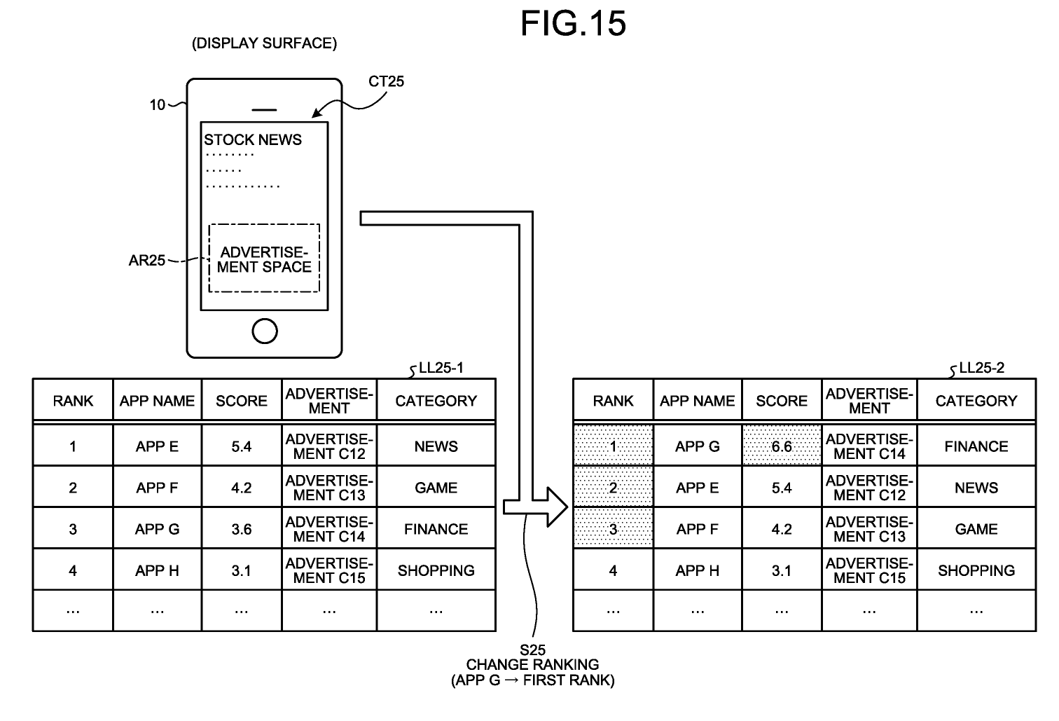

Next, a case of varying the ranking according to content including an advertisement space that is the advertisement display area where the advertisement is displayed will be described using FIG. 15. In the example of FIG. 15, a case in which the determination device 100 changes the ranking according to information included in the content including the advertisement space where the advertisement is displayed and the categories of the advertisements will be described. That is, the example of FIG. 15 illustrates a case in which the determination device 100 changes the ranking according to relationship between the content (display surface) of a web page or the like where the advertisement is displayed and the categories of the advertisements. Note that description of similar points to the example illustrated in FIGS. 11 to 14 is appropriately omitted.

Ranking information LL25-1 illustrated in FIG. 15 indicates a case in which the category of the advertisement of the app E is “news”, the category of the advertisement of the app F is “game”, the category of the advertisement of the app G is “finance”, and the category of the advertisement of the app H is “shopping”.

Here, the determination device 100 changes the ranking according to content CT25 including an advertisement space AR25 where the advertisement is displayed (step S25). For example, the determination device 100 generates ranking information LL25-2 by changing the ranking indicated in the ranking information LL25-1 on the basis of an affinity between the content of the content CT25 and the categories of the advertisements.

In the example of FIG. 15, the content CT25 including the advertisement space AR25 is content regarding stock news. Therefore, the determination device 100 changes the advertisement of the app G of the category “finance”. To be specific, the determination device 100 increases the score of the advertisement of the app G ranked third by “3”. Accordingly, the score of the advertisement of the app G ranked third becomes “6.6”, and becomes larger than the score “5.4” of the advertisement of the app E ranked first and the score “4.2” of the advertisement of the app F ranked second. Therefore, the determination device 100 switches the rank of the advertisement of the app E, the rank of the advertisement of the app F, and the rank of the advertisement of the app G as illustrated in the ranking information LL25-2. To be specific, the determination device 100 changes the ranking by causing the advertisement of the app G to be ranked “first”, the advertisement of the app E to be ranked “second”, and the advertisement of the app F to be ranked “third”. In this case, the determination device 100 distributes the advertisement of the app G ranked “first” in distributing one advertisement on the basis of the ranking.

Note that the ranking change illustrated in FIGS. 11 to 15 is an example, and the ranking may be changed on the basis of any information. For example, the determination device 100 may change the ranking on the basis of budgets of the advertisements or distribution periods. For example, the determination device 100 may change the ranking such that the ranking of the advertisement having a larger budget is ranked higher. Further, for example, the determination device 100 may change the ranking such that the advertisement with the distribution period coming to an end is ranked higher.

5. Flow of Determination Processing by Ranking Change

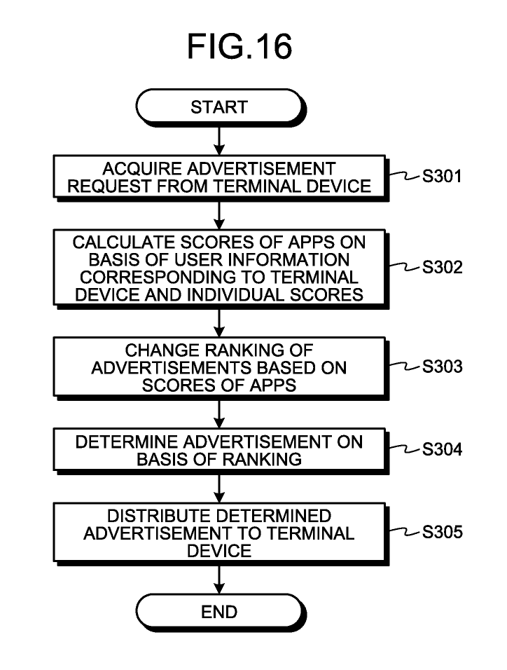

Next, a procedure of determination processing including ranking change based on various types of information will be described using FIG. 16. FIG. 16 is a flowchart illustrating an example of determination processing by ranking change according to an embodiment.

As illustrated in FIG. 16, the acquisition unit 131 of the determination device 100 acquires the advertisement request from the terminal device 10 (step S301). After that, the calculation unit 133 of the determination device 100 calculates the scores of the apps on the basis of the user information corresponding to the terminal device 10 and the individual scores (step S302). For example, the calculation unit 133 calculates the score of the app A about the user U1 on the basis of the individual score information 124-1 regarding the app A and the user information of the user U1.

After that, the determination unit 134 of the determination device 100 changes the ranking of the advertisements based on the scores of the apps (step S303). For example, the determination unit 134 changes the ranking of the advertisements based on the scores of the apps on the basis of various types of information. For example, the determination unit 134 changes the ranking of the advertisements based on the scores of the apps on the basis of various types of information, as illustrated in FIGS. 11 to 15. After that, the determination unit 134 determines the advertisement on the basis of the ranking (step S304). After that, the distribution unit 135 of the determination device 100 distributes the determined advertisement to the terminal device 10 (step S305).

6. Determination of Advertisement Based on Rarity of User

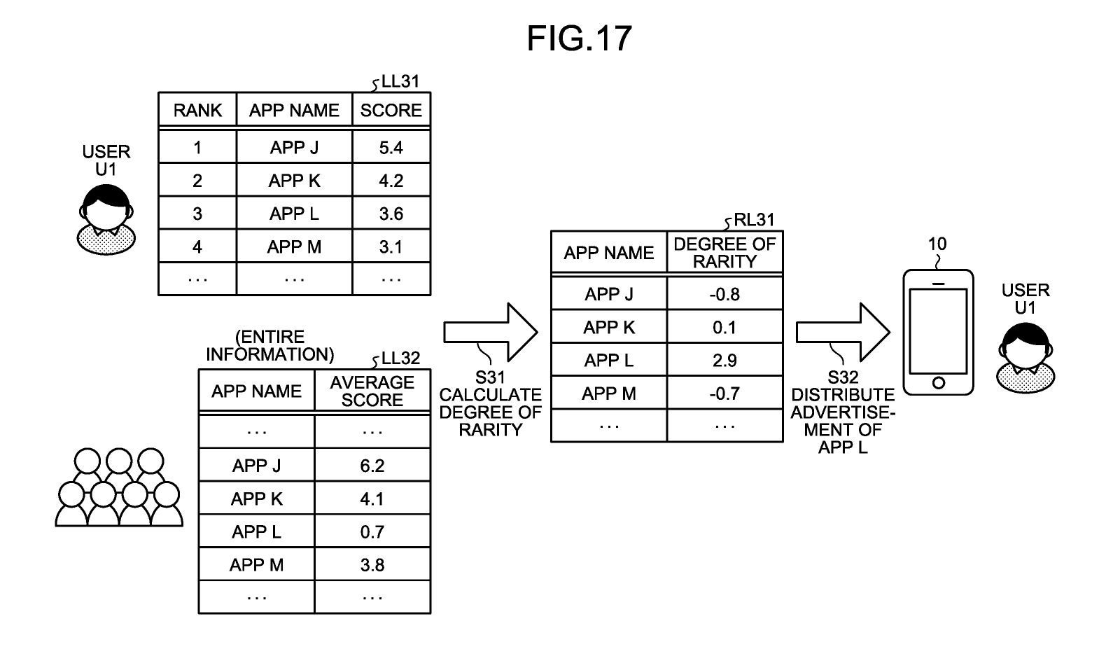

In the above example, an example of determining the advertisement to be distributed according to the scores of the apps for each user has been described. However, the determination device 100 may determine the advertisement to be distributed on the basis of the rarity in the apps, of the user who uses the terminal device 10. This point will be described using FIG. 17. FIG. 17 is a diagram illustrating an example of determination of an advertisement on the basis of rarity of a user in apps according to an embodiment.

Ranking information LL31 illustrated in FIG. 17 indicates ranking information of the user U1. The ranking information LL31 indicates a case in which the app J having the largest score “5.4” is ranked “first”, the app K having the next largest score “4.2” to the app J is ranked “second”, the app L having the next largest score “3.6” to the app K is ranked “third”, and the app M having the next largest score “3.1” to the app L is ranked “fourth”.

Further, tendency information LL32 illustrated in FIG. 17 indicates information based on the scores calculated for a plurality of users. To be specific, the tendency information LL32 indicates averages of the scores of the apps (hereinafter, also referred to as “average scores”) calculated for the plurality of users. Note that the tendency information LL32 may be information targeting any users as long as the information indicates a tendency of many users. For example, the tendency information LL32 may include information of all the users who are targets to which the advertisement is distributed, or may include information of a user similar to the user U1. Further, the tendency information LL32 may include the information of the user U1.

In the example of FIG. 17, the entire information LL32 indicates a case in which the average score of the app J is “6.2”, the average score of the app K is “4.1”, the average score of the app L is “0.7”, and the average score of the app M is “3.8”.

The determination device 100 calculates the degrees of rarity of the user U1 in the apps (step S31). For example, the determination device 100 calculates the degrees of rarity of the user U1 in the apps on the basis of the ranking information LL31 and the tendency information LL32. In the example of FIG. 17, the determination device 100 calculates the degrees of rarity according to differences between the scores of the apps of the user U1 in the ranking information LL31, and the average scores of the corresponding apps in the tendency information LL32, as illustrated in a degree of rarity list RL31.

For example, the determination device 100 calculates the degree of rarity “−0.8” of the user U1 in the app J by subtracting the average score “6.2” of the app J in the tendency information LL32 from the score “5.4” of the app J in the ranking information LL31. In FIG. 17, the score “5.4” of the app J of the user U1 is smaller than the average score “6.2” of the app J. That is, the degree of rarity “−0.8” of the user U1 in the app J indicates that the degree of rarity of the user U1 in the app J is low. That is, the degree of rarity “−0.8” indicates that the possibility of the user U1 installing the app J is smaller than the tendency of all the users included in the targets of the tendency information LL32. Further, similarly, the degree of rarity “−0.7” of the user U1 in the app M indicates that the degree of rarity of the user U1 in the app M is low.

Further, for example, the determination device 100 calculates the degree of rarity “0.1” of the user U1 in the app K by subtracting the average score “4.1” of the app K in the tendency information LL32 from the score “4.2” of the app K in the ranking information LL31. In FIG. 17, the score “4.2” of the app K of the user U1 approximates to the average score “4.1” of the app J. That is, the degree of rarity “0.1” of the user U1 in the app K indicates that the degree of rarity of the user U1 in the app K is average. That is, the degree of rarity “0.1” indicates that the possibility of the user U1 installing the app J conforms to the tendency of all the users included in the targets of the tendency information LL32.

Further, for example, the determination device 100 calculates the degree of rarity “2.9” of the user U1 in the app L by subtracting the average score “0.7” of the app L in the tendency information LL32 from the score “3.6” of the app L in the ranking information LL31. In FIG. 17, the score “3.6” of the user U1 in the app L is larger than the average score “0.7” of the app L. That is, the degree of rarity “2.9” of the user U1 in the app L indicates that the degree of rarity of the user U1 in the app L is high. That is, the degree of rarity “2.9” indicates that the possibility of the user U1 installing the app L is higher than the tendency of all the users included in the targets of the tendency information LL32.

Therefore, in the example illustrated in FIG. 17, the determination device 100 determines the advertisement of the app L as the advertisement to be distributed to the terminal device 10 of the user U1 (step S32). That is, the determination device 100 determines the advertisement of the app L ranked “third” and having a high degree of rarity, as the advertisement to be distributed to the terminal device 10 of the user U1, instead of the advertisement of the app J and the advertisement of the app K, because the degrees of rarity in the app J ranked “first” and the app K ranked “second” are not high. Accordingly, the determination device 100 can determine the advertisement to be distributed on the basis of not only simple comparison between the scores of the content (apps) in the user, but also relative comparison with other users.

For example, the app L having a low average score in the tendency information LL32 is an app having a low probability of being installed in the tendency of all the users included in the targets of the tendency information LL32. Therefore, the determination device 100 has a low probability to determine the advertisement of the app L as the advertisement to be distributed. Meanwhile, the score of the app L in the ranking information LL31 regarding the user U1 is “3.6”, and is ranked third, which is high. Therefore, the user U1 deviates from the tendency of all the users included in the targets of the tendency information LL32, and is a user having a relatively high probability to install the app L in all the users. Therefore, the determination device 100 can increase the probability of distributing the advertisement of the app L by distributing the advertisement of the app L to the terminal device 10 of the user U1, instead of the app J or the app K having a high score, in all the users included in the targets of the tendency information LL32. Accordingly, the determination device 100 can optimize the entire advertisement distribution.

Note that the calculation of the degree of rarity and the determination of the advertisement based on the degree of rarity are examples, and the degree of rarity may be calculated and the advertisement to be distributed may be determined by various methods. For example, the determination device 100 may determine the advertisement to be distributed on the basis of the degrees of rarity according to the degrees of rarity and the advertisement stocks of the apps. For example, the determination device 100 may determine, in a case where large quantities in stock of the advertisement of the app having a high degree of rarity remain, the advertisement of the app calculated to have a high degree of rarity as the advertisement to be distributed on the basis of the degree of rarity. In this case, the determination device 100 can distribute the appropriate advertisement on the basis of various conditions not only by simply comparing the scores of the content in the user, but also by determining the advertisement to be distributed to the user by balancing the degree of rarity and the advertisement stock.

7. Effect

As described above, the determination device 100 according to the embodiment includes the acquisition unit 131, the calculation unit 133, and the determination unit 134. The acquisition unit 131 acquires the user information that is the information regarding the user who uses the terminal device 10 that becomes the providing destination of the content. Further, the calculation unit 133 calculates the scores regarding the probability of the user performing a predetermined behavior for the plurality of pieces of content on the basis of the user information acquired by the acquisition unit 131. The determination unit 134 determines the distribution content to be distributed to the terminal device 10 on the basis of the scores of the pieces of content calculated by the calculation unit 133.

Accordingly, the determination device 100 according to the embodiment calculates the scores regarding the probability of the user performing a predetermined behavior for the plurality of pieces of content, and determines the advertisement of the app to be distributed to the terminal device 10 on the basis of the calculated scores, thereby to appropriately determine the distribution content to be distributed to the terminal device 10. That is, the determination device 100 can distribute the advertisement of the app having a high probability of being installed by the user, to the terminal device 10 of the user, thereby to improve the advertisement effect.

Further, in the determination device 100 according to the embodiment, the calculation unit 133 calculates the scores of the plurality of pieces of content on the basis of the individual score for each user information.

Accordingly, the determination device 100 according to the embodiment can appropriately determine the content to be distributed to the terminal device 10 according to the scores on the basis of the individual scores generated for each user information.

Further, in the determination device 100 according to the embodiment, the calculation unit 133 calculates the scores of the plurality of pieces of content on the basis of the individual scores generated for each user information including the user attribute information that is the information indicating the attributes of the user.

Accordingly, the determination device 100 according to the embodiment can appropriately determine the content to be distributed to the terminal device 10 according to the scores on the basis of the individual scores generated for each user information including the user attribute information.

Further, in the determination device 100 according to the embodiment, the calculation unit 133 calculates the scores of the plurality of pieces of content on the basis of the individual scores generated for each user information including the terminal information that is the information regarding the terminal device 10.

Accordingly, the determination device 100 according to the embodiment can appropriately determine the content to be distributed to the terminal device 10 according to the scores on the basis of the individual scores generated for each user information including the terminal information.

Further, in the determination device 100 according to the embodiment, the determination unit 134 determines the distribution content to be distributed to the terminal device 10 on the basis of the degree of rarity of the user to one piece of content calculated on the basis of the score of the one piece of content in the user who uses the terminal device 10, and the scores of the one piece of content in other users.

Accordingly, the determination device 100 according to the embodiment can appropriately determine the content to be distributed to the terminal device 10 on the basis of the rarity of the user who uses the terminal device 10 in the pieces of content.

Further, in the determination device 100 according to the embodiment, the determination unit 134 determines the distribution content to be distributed to the terminal device 10 on the basis of the degree of rarity of the user to one piece of content calculated on the basis of the difference between the score of the one piece of content in the user who uses the terminal device 10, and an average of the scores of the one piece of content in the plurality of users.

Accordingly, the determination device 100 according to the embodiment can appropriately determine the content to be distributed to the terminal device 10 on the basis of the rarity indicating how much the user who uses the terminal device 10 deviates from the average of all the users, about the pieces of content.

Further, in the determination device 100 according to the embodiment, the calculation unit 133 calculates the scores regarding the probability of the user performing installation for the plurality of applications that is the plurality of pieces of content. The determination unit 134 determines the distribution content to be distributed to the terminal device 10, of the plurality of applications, on the basis of the scores of the applications calculated by the calculation unit 133.

Accordingly, the determination device 100 according to the embodiment calculates the scores regarding the probability of the user performing installation for the plurality of apps, and determines the distribution content to be distributed to the terminal device 10 on the basis of the calculated scores, thereby to appropriately determine the content to be distributed to the terminal device 10. That is, the determination device 100 can distribute the advertisement of the app having a high probability of being installed to the user, to the terminal device 10 of the user, thereby to improve the advertisement effect.

Further, in the determination device 100 according to the embodiment, the determination unit 134 determines the advertisement of the application to be distributed to the terminal device 10 on the basis of the ranking of the applications according to the scores of the applications.

Accordingly, the determination device 100 according to the embodiment can appropriately determine the advertisement of the app to be distributed to the terminal device 10 on the basis of the ranking of the applications according to the scores of the plurality of apps.

Further, in the determination device 100 according to the embodiment, the determination unit 134 determines the advertisement of the application to be distributed to the terminal device 10 on the basis of the ranking varied according to the information regarding the prices of the applications in the advertisement distribution.

Accordingly, the determination device 100 according to the embodiment can appropriately determine the content to be distributed to the terminal device 10 on the basis of the ranking varied according to the information regarding the prices of the applications in the advertisement distribution. That is, the determination device 100 can perform flexible advertisement distribution by enabling the distribution of the advertisement in consideration of the information regarding the stock such as the quantities in stock of the apps.

Further, in the determination device 100 according to the embodiment, the determination unit 134 determines the advertisement of the application to be distributed to the terminal device 10 on the basis of the ranking varied according to the information regarding the stock of the advertisements of the applications.

Accordingly, the determination device 100 according to the embodiment can appropriately determine the content to be distributed to the terminal device 10 on the basis of the ranking varied according to the information regarding the stock of the advertisements of the applications. That is, the determination device 100 can perform flexible advertisement distribution by enabling the distribution of the advertisement in consideration of the information regarding the prices such as the bid prices of the advertisements of the apps.

Further, in the determination device 100 according to the embodiment, the determination unit 134 determines the advertisement of the application to be distributed to the terminal device 10 on the basis of the ranking varied according to the time to distribute the advertisement.

Accordingly, the determination device 100 according to the embodiment can appropriately determine the content to be distributed to the terminal device 10 on the basis of the ranking varied according to the time to distribute the advertisement. That is, the determination device 100 determines the advertisement to be distributed on the basis of the ranking in consideration of the time to distribute the advertisement, thereby to further improve the advertisement effect.

Further, in the determination device 100 according to the embodiment, the determination unit 134 determines the advertisement of the application to be distributed to the terminal device 10 on the basis of the ranking varied according to the information regarding the user operation to the advertisements of the applications.

Accordingly, the determination device 100 according to the embodiment can appropriately determine the content to be distributed to the terminal device 10 on the basis of the ranking varied according to the information regarding the user operation to the advertisements of the applications. That is, the determination device 100 determines the advertisement to be distributed on the basis of the ranking in consideration of the information regarding the user operation to the advertisements of the apps, such as the CTR, thereby to further improve the advertisement effect.

Further, in the determination device 100 according to the embodiment, the determination unit 134 determines the advertisement of the application to be distributed to the terminal device 10 on the basis of the ranking varied according to the content including the advertisement display area where the advertisement is displayed.

Accordingly, the determination device 100 according to the embodiment can appropriately determine the content to be distributed to the terminal device 10 on the basis of the ranking varied according to the content including the advertisement display area (advertisement space) where the advertisement is displayed. That is, the determination device 100 determines the advertisement to be distributed on the basis of the ranking in consideration of the content including the advertisement space, thereby to further improve the advertisement effect.

8. Hardware Configuration

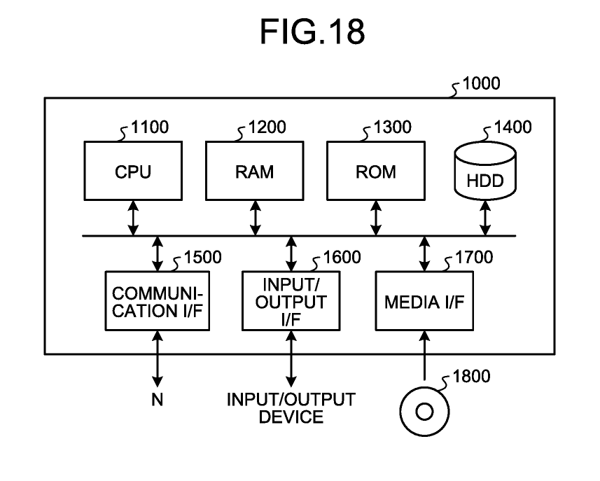

The above-described determination device 100 according to the embodiment is realized by a computer 1000 having a configuration as illustrated in FIG. 18, for example. FIG. 18 is a hardware configuration diagram illustrating an example of the computer that realizes functions of the determination device. The computer 1000 includes a CPU 1100, a RAM 1200, a ROM 1300, an HDD 1400, a communication interface (I/F) 1500, an input/output interface (I/F) 1600, and a media interface (I/F) 1700.

The CPU 1100 is operated on the basis of programs stored in the ROM 1300 or the HDD 1400, and controls units. The ROM 1300 stores a boot program executed by the CPU 1100 at the time of start of the computer 1000, a program depending on the hardware of the computer 1000, and the like.

The HDD 1400 stores a program executed by the CPU 1100, data used by the program, and the like. The communication interface 1500 receives data from another device through a network N and sends the data to the CPU 1100, and transmits data determined by the CPU 1100 to another device through the network N.

The CPU 1100 controls output devices such as a display and a printer, and input devices such as keyboard and a mouse through the input/output interface 1600. The CPU 1100 acquires data from the input device through the input/output interface 1600. Further, the CPU 1100 outputs determined data to the output device through the input/output interface 1600.

The media interface 1700 reads a program or data stored in a recording medium 1800, and provides the program or data to the CPU 1100 through the RAM 1200. The CPU 1100 loads the program from the recording medium 1800 onto the RAM 1200 through the media interface 1700, and executes the loaded program. The recording medium 1800 is, for example, an optical recording medium such as a digital versatile disc (DVD) or a phase change rewritable disk (PD), a magneto-optical recording medium such as magneto-optical disk (MO), a tape medium, a magnetic recording medium, or a semiconductor memory.

For example, in a case where the computer 1000 functions as the determination device 100 according to the embodiment, the CPU 1100 of the computer 1000 controls the functions of the control unit 130 by executing the programs loaded on the RAM 1200. The CPU 1100 of the computer 1000 reads the programs from the recording medium 1800 and executes the programs. However, as another example, the CPU 1100 may acquire the programs from another device through the network N.

As described above, some embodiments and modifications of the present application have been described in detail on the basis of the drawings. However, these embodiments and modifications are examples, and the present invention can be implemented in other forms to which various alternations and improvements are applied on the basis of the knowledge of a person skilled in the art, starting with the aspects described in the disclosed rows of the invention.

9. Others

All or a part of the processing described as those automatically performed, of the processing described in the embodiments and modifications, can be manually performed, or all or a part of the processing described as those manually performed, of the processing described in the embodiments and modifications, can be automatically performed by a known method. In addition, the processing processes, the specific names, and the information including the various data and parameters described and illustrated in the documents and the drawings can be arbitrarily changed unless otherwise specified. For example, the various types of information illustrated in the drawings are not limited thereto.

Further, the illustrated configuration elements of the devices are functionally and conceptually illustrated, and are not necessarily physically configured as illustrated in the drawings. That is, the specific forms of distribution/integration of the devices are not limited to the illustrated forms, and all or a part of the forms can be functionally or physically configured in a distributed/integrated manner in arbitrary units according to various loads and a status of use.

Further, the above-described embodiments and modifications can be arbitrarily combined within a range where the processing content is consistent.

Further, the above-described “unit (or section or module”) can be read as “means” or “circuit”. For example, the acquisition unit can be read as acquisition means or acquisition circuit.

According to one aspect of an embodiment, an effect to appropriately determine content to be distributed to a terminal device is exerted.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A determination device comprising:
an acquisition unit that acquires user information that is information regarding a user who uses a terminal device that becomes a providing destination of content;
a calculation unit that calculates scores regarding a probability of the user performing a predetermined behavior for a plurality of pieces of the content on the basis of the user information acquired by the acquisition unit; and
a determination unit that determines distribution content to be distributed to the terminal device on the basis of the scores of the plurality of pieces of content calculated by the calculation unit.

2. The determination device according to claim 1, wherein
the calculation unit calculates the scores of the plurality of pieces of content on the basis of individual scores generated for each of the user information.

3. The determination device according to claim 2, wherein
the calculation unit calculates the scores of the plurality of pieces of content on the basis of the individual scores generated for each of the user information including user attribute information that is information indicating an attribute of the user.

4. The determination device according to claim 2, wherein
the calculation unit calculates the scores of the plurality of pieces of content on the basis of the individual scores generated for each of the user information including terminal information that is information regarding the terminal device.

5. The determination device according to claim 1, wherein
the determination unit determines the distribution content to be distributed to the terminal device on the basis of the degree of rarity for one piece of the content of the user, the degree of rarity being calculated on the basis of the score of the one piece of content in the user who uses the terminal device and the score of the one piece of content in another user.

6. The determination device according to claim 5, wherein
the determination unit determines the distribution content to be distributed to the terminal device on the basis of the degree of rarity for the one piece of content of the user, the degree of rarity being calculated on the basis of a difference between the score of the one piece of content in the user who uses the terminal device, and an average of the scores of the one piece of content in a plurality of users.

7. The determination device according to claim 1, wherein
the calculation unit calculates scores regarding a probability of the user performing installation of a plurality of applications that is the plurality of pieces of content, and
the determination unit determines the distribution content to be distributed to the terminal device, of the plurality of applications, on the basis of the scores of the applications calculated by the calculation unit.

8. The determination device according to claim 7, wherein
the determination unit determines an advertisement of the application to be distributed to the terminal device on the basis of a ranking of the applications according to the scores of the applications.

9. The determination device according to claim 8, wherein
the determination unit determines the advertisement of the application to be distributed to the terminal device on the basis of the ranking varied according to information regarding prices of the applications in advertisement distribution.

10. The determination device according to claim 8, wherein
the determination unit determines the advertisement of the application to be distributed to the terminal device on the basis of the ranking varied according to information regarding stock of the advertisements of the applications.

11. The determination device according to claim 8, wherein
the determination unit determines the advertisement of the application to be distributed to the terminal device on the basis of the ranking varied according to a time to distribute the advertisement.

12. The determination device according to claim 8, wherein
the determination unit determines the advertisement of the application to be distributed to the terminal device on the basis of the ranking varied according to information regarding a user operation to the advertisements of the applications.

13. The determination device according to claim 8, wherein
the determination unit determines the advertisement of the application to be distributed to the terminal device on the basis of the ranking varied according to the content including an advertisement display area where the advertisement is displayed.

14. A determination method executed by a computer, the determination method comprising the steps of:
acquiring user information that is information regarding a user who uses a terminal device that becomes a providing destination of content;
calculating scores regarding a probability of the user performing a predetermined behavior for a plurality of pieces of the content on the basis of the user information acquired by the acquiring step; and
determining distribution content to be distributed to the terminal device on the basis of the scores of the plurality of pieces of content calculated by the calculating step.

15. A non-transitory computer readable storage medium having stored therein a determination program for causing a computer to execute the processes of:
acquiring user information that is information regarding a user who uses a terminal device that becomes a providing destination of content;
calculating scores regarding a probability of the user performing a predetermined behavior for a plurality of pieces of the content on the basis of the user information acquired by the acquiring process; and
determining distribution content to be distributed to the terminal device on the basis of the scores of the plurality of pieces of content calculated by the calculating process.
